(19) United States
(12) Patent Application Publication
(10) Pub. No.: US 2021/0312122 A1
(43) Pub. Date: Oct. 7, 2021

(54) METHODS AND SYSTEMS FOR GENERATING DOCUMENTS WITH A TARGETED STYLE

(71) Applicant: INTERNATIONAL BUSINESS MACHINES CORPORATION, Armonk, NY (US)

(72) Inventors: Fearghal O'DONNCHA, Aran Islands (IE); Albert AKHRIEV, MULHUDDART (IE); Yufang HOU, Dublin (IE); Charles Arthur JOCHIM, Dublin (IE)

(73) Assignee: INTERNATIONAL BUSINESS MACHINES CORPORATION, Armonk, NY (US)

(21) Appl. No.: 16/842,133

(22) Filed: Apr. 7, 2020

(51) Int. Cl. G06F 40/205; G06F 40/30

(52) U.S. Cl. CPC G06F 40/205; G06F 40/30

(57) ABSTRACT

Embodiments for generating text with a target style are provided. A target corpus is analyzed to determine a style representation associated with the target corpus. A source text is analyzed to determine a meaning representation associated with the source text. A target text is generated utilizing the target style representation associated with the target corpus and the meaning representation associated with the source text.

### BACKGROUND OF THE INVENTION

### Field of the Invention

The present invention relates in general to computing systems, and more particularly, to various embodiments for generating documents with a targeted style.

### Description of the Related Art

The effectiveness of written communication (e.g., text) depends on, for example, the use of appropriate style, tone, descriptiveness, concision, and vocabulary (or overall “style”) given the intended reader(s) (and/or audience). For example, although an article in a scientific journal may cover some general concepts that are understandable by audiences for which they were not intended (e.g., elementary school students), such a text is often written in such a style that is very difficult for unintended audiences to read and/or understand (e.g., because of the use of advanced terminology, the use of some words in an usual manner, etc.).

Although solutions currently exist that may assist in checking spelling and/or grammar, using synonyms/antonyms, paraphrasing some previously created content, and translating content from one natural language to another, little work has been directed at editing content (e.g., text) in such a way that it has a style suitable for a particular audience.

### SUMMARY OF THE INVENTION

Various embodiments for generating text with a target style, by a processor, are provided. A target corpus is analyzed to determine a style representation associated with the target corpus. A source text is analyzed to determine a meaning representation associated with the source text. A target text is generated utilizing the target style representation associated with the target corpus and the meaning representation associated with the source text.

In addition to the foregoing exemplary embodiment, various other system and computer program product embodiments are provided and supply related advantages. The foregoing Summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block diagram of a system for generating text with a target style according to an embodiment of the present invention; and

FIG. 5 is a flowchart diagram of an exemplary method for generating text with a target style according to an embodiment of the present invention.

### DETAILED DESCRIPTION OF THE DRAWINGS

As discussed above, the effectiveness of written communication (e.g., text) depends on, for example, the use of appropriate style, tone, descriptiveness, concision, and vocabulary (or overall “style”) given the intended reader(s) (and/or audience). For example, although an article in a scientific journal may cover some general concepts that are understandable by audiences for which they were not intended (e.g., elementary school students), such a text is often written in such a style that is very difficult for unintended audiences to read and/or understand (e.g., because of the use of advanced terminology, the use of some words in an usual manner, etc.).

Solutions currently exist that may assist users (or content creators, authors, etc.) in checking spelling and/or grammar, using synonyms/antonyms, and paraphrasing some previously created content. Also, automated translation systems are available, which convert a text from one natural/spoken language to another. However, little work has been directed at editing content (e.g., text) in such a way that it has a style suitable for a particular audience. That is, current solutions generally focus on copyediting text towards grammatically correct sentences and/or translating content from one language to another, while having little, if any, effect on the text's “appropriateness” for particular audiences and/or within particular domains.

To address these needs and/or the shortcomings in the prior art, in some embodiments described herein, methods and/or systems are disclosed that, for example, provide a framework that assists users (e.g., content creators, authors, etc.) in communicating a message(s) or text (e.g., user-defined) to a specific audience or domain (e.g., user-defined). More particularly, in some embodiments, the methods and systems described herein have the ability to (automatically) parse and extract the tone, vocabulary, and expressions (or overall style) in a body of text and adjust it towards a specific forum or domain (e.g., the readers of a particular journal, magazine, etc.).

That is, in some embodiments, the methods and systems analyze a target corpus to determine the “style” which with the text within is written (and/or generate a representation thereof). That style is then used to alter (or edit, etc.) another document (e.g., a source text) in such a way that it is written in the same (or relatively similar) style as the target corpus while maintaining the original “meaning” (e.g., ideas expressed, basic topics, etc.) of the source text.

The methods and systems described herein may benefit various computing systems and processes that are utilized to communicate with humans, including those that perform various natural language processing (NLP) and/or natural language understanding (NLU) techniques, as the ability to communicate with users in different applications, professions, scenarios, etc. is provided (e.g., communicating highly technical material to a group of investors with no technical background or, conversely, communicating investment material to a group of engineers with no investing experience).

In some embodiments, methods and/or systems are provided that (automatically) change (or alter, edit, etc.) the style of a body of text towards a user-defined domain (or style) such as a scientific (e.g., Society for Industrial and Applied Mathematics (SIAM)) or economics (e.g. Financial Times) journal (e.g., as indicated by a corpus of documents/texts that are associated with the desired style/domain).

In some embodiments, with respect to semantic interpretation of text, “style” may be defined as the difference between the meaning of text (e.g., in a general sense) and the meaning of the text within the topic/domain, etc. of the particular document/text. Such may be utilized in some embodiments described herein, as a representation (e.g., a mathematical representation) of a style of a target corpus (i.e., the document(s) selected as having the desired style) may be determined based on the difference between a language model associated with the target corpus and a language model associated with the language (e.g., natural/spoken language) used for the document(s). In some embodiments, the methods/systems described herein modify the “style” of a source document (or text) from one style (i.e., the original style of the source document) to another style (i.e., the determined style of the target corpus) while leaving the “topic” (or meaning, etc.) the same.

The system may include (and/or utilize), for example, a style extract (or extraction) model, a semantic parsing model, a discourse planner, and a general language model. The style extract model may identify and extract (or determine) a target style representation from a corpus of target text (e.g., papers, articles, etc. from a particular scientific journal, a business magazine, etc.). The semantic parsing model may extract a meaning (or semantic) representation from a source text (e.g., the text/document that is selected to be modified). The discourse planner may identify (and/or determine) a meaning representation at a whole discourse level (i.e., for the source text as a whole). The general language model may be utilized to generate a target text based on the target style representation and the output of the discourse planner. The overall output (or result) may be a document (or target text) having the same (overall) “meaning” of the source text but written in the style of the target corpus (i.e., the user-selected domain, style, venue, etc.).

At least some of the aspects of functionality described herein may be performed utilizing a cognitive analysis (or machine learning technique). The cognitive analysis may include natural language processing (NLP), natural language understanding (NLU) and/or NLP/NLU technique, such classifying natural language, analyzing tone, and analyzing sentiment (e.g., scanning for keywords, key phrases, etc.) with respect to, for example, content (or text) within documents, communications sent to and/or received by users, and/or other available data sources. In some embodiments, natural language processing (NLP), Mel-frequency cepstral coefficients (MFCCs) (e.g., for audio content/speech detected by a microphone), and/or region-based convolutional neural network (R-CNN) pixel mapping (e.g., for object detection/classification in images/videos), as are commonly understood, are used. As such, it should be understood that the methods and systems described herein may be applied to audio content (e.g., documents read out loud, a speech/presentation, etc.).

As such, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art. Generally, these processes may include, for example, receiving and/or retrieving multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, generating text with a target (or targeted) style, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

In particular, in some embodiments, a method for generating text with a target style, by a processor, is provided. A target corpus is analyzed to determine a style representation associated with the target corpus. A source text is analyzed to determine a meaning representation associated with the source text. A target text is generated utilizing the target style representation associated with the target corpus and the meaning representation associated with the source text.

The analyzing of the target corpus to determine the style representation may include determining a difference between a target language model associated with the target corpus and a general language model. The analyzing of the target corpus to determine the style representation may further include training the target language model utilizing the target corpus.

The analyzing of the source text may be performed utilizing a semantic parsing model. The meaning representation associated with the target corpus may include at least one of an Abstract Meaning Representation (AMR) and a Rhetorical Structure Theory (RST) representation.

The target corpus may include a plurality of text documents. A style associated with the target corpus may be different than a style associated with the source text. A meaning associated with the source text may be different than a meaning associated with the target corpus.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment, such as cellular networks, now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

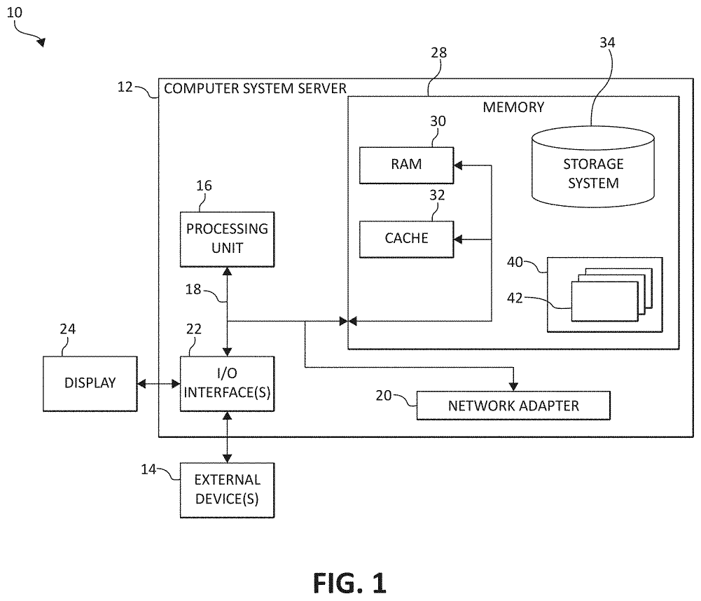

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in, for example, personal computer systems, server computer systems, thin clients, thick clients, hand-held or laptop devices, multiprocessor systems, microprocessor-based systems, set top boxes, programmable consumer electronics, network PCs, mobile electronic devices such as mobile (or cellular and/or smart) phones, personal data assistants (PDAs), tablets, wearable technology devices, laptops, handheld game consoles, portable media players, etc., as well as computing systems in vehicles, such as automobiles, aircraft, watercrafts, etc. However, in some embodiments, some of the components depicted in FIG. 1 may be located in a computing device in, for example, a satellite, such as a Global Position System (GPS) satellite. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

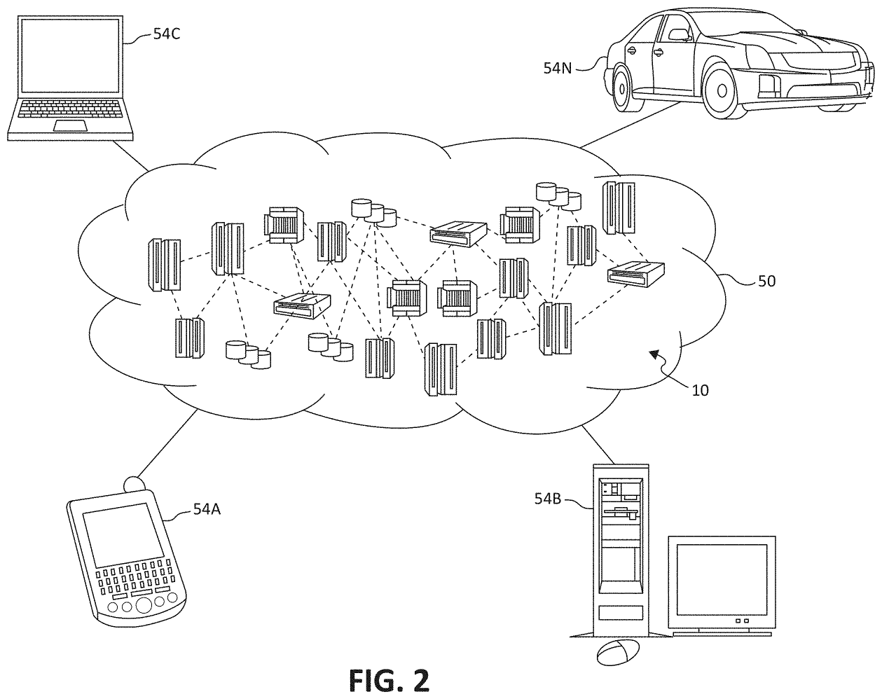

Referring now to FIG. 2, illustrative cloud computing environment 50 is depicted. As shown, cloud computing environment 50 comprises one or more cloud computing nodes 10 with which local computing devices used by cloud consumers, such as, for example, cellular (or mobile) telephone or PDA 54A, desktop computer 54B, laptop computer 54C, and vehicular computing system (e.g., integrated within automobiles, aircraft, watercraft, etc.) 54N may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

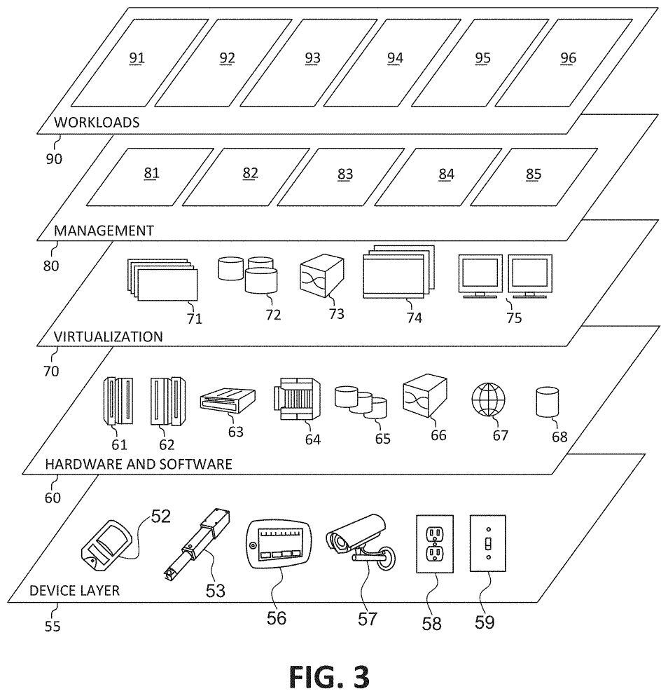

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator, washer/dryer, or air conditioning unit, and a wide variety of other possible interconnected devices/objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for generating text with a target (or targeted) style, as described herein. One of ordinary skill in the art will appreciate that the workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, some methods and/or systems described herein provide, for example, a framework that assists users (e.g., content creators, authors, etc.) in communicating a message(s) or text (e.g., user-defined) to a specific audience or domain (e.g., user-defined). More particularly, in some embodiments, the methods and systems described herein have the ability to (automatically) parse and extract the tone, vocabulary, and expressions (or overall style) in a body of text and adjust it towards a specific forum or domain (i.e. particular journal, magazine, etc.). That is, in some embodiments, the methods and systems analyze a target corpus to determine the “style” which with the document(s) within is written. That style is then used to alter (or edit, etc.) another document (e.g., a source text) in such a way that it is written or composed in the same (or relatively similar) style as the target corpus, while maintaining the original “meaning” (e.g., ideas expressed, basic topics, etc.) of the source text.

In particular, in some embodiments, methods and/or systems that amend the style and representation of a body of text (or source text) towards a style of a target corpus are provided. The system(s) (and/or method(s)) may provide the modification of the body of text from one style (e.g., an incorrect or imperfect form for a particular audience), towards a specific target style (or domain) with specific terminology, structure, etc. This modification may be performed while maintaining the original meaning (or “substance”) of the source text.

Also, in some embodiments, the “explainability” of the methods/systems described herein may be enhanced by, for example, providing the user with various types of information. For example, the user may be allowed to select (e.g., highlight) text in the target text (or document) and/or the source text. In response, the system may generate indications related to domain-specific terminology, probabilities, etc. related to the “translation” performed by the system (i.e., converting the source text from its original style to the target style).

In some embodiments, the system utilizes a style extract model to identify and extract the target style representation from the target corpus of target text, and a semantic parsing model to extract a meaning representation from the source text. Also, a discourse planner may be utilized to identify a meaning representation at a whole discourse level (for the source text), and a general language model may be utilized to produce the target text based on the target style representation and the output of the discourse planner.

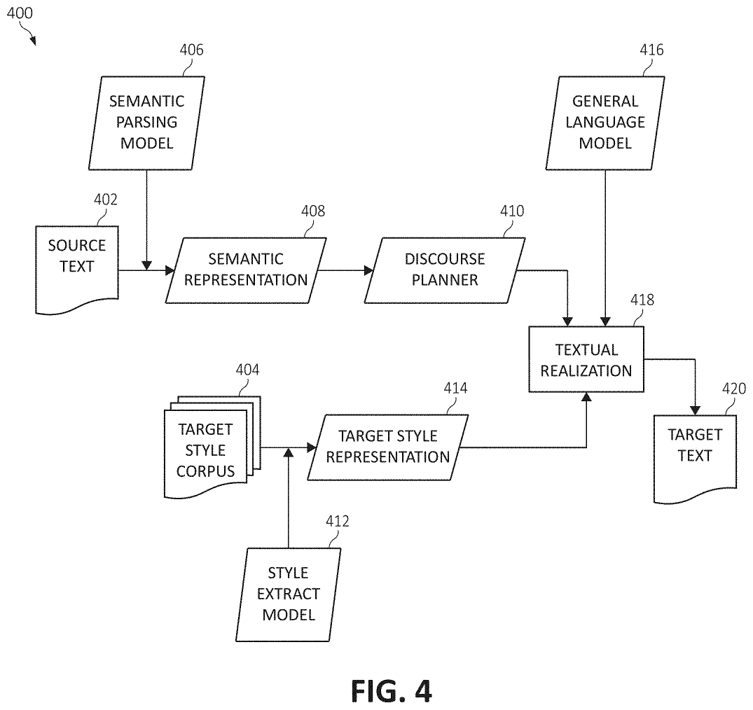

FIG. 4 illustrates a system (and/or method) 400 for generating text with a target style and/or transferring a style from one text to another, according to an embodiment of the present invention. It should be understood that the various steps and functionality described below with respect to FIG. 4 (and/or any other embodiments described herein) may be performed in orders other than those specifically described. The system 400 receives (and/or detects) a source text 402 and a target corpus 404.

The source text 402 may be any suitable type of document(s) that includes text, such as text-based documents, websites, web pages, unstructured/semi-structured/unstructured documents, etc. (i.e., any suitable type of electronic and/or physical document from which text and/or alphanumeric characters may be extracted and/or identified), such as those related to particular fields, such as scientific fields, engineering, mathematics, economics, or any other subject. As such, the source text 402 (as received) may be written, composed, arranged, formatted, etc. in a particular style (i.e., a first style, original style, source style, etc.) The source text 402 may be the document(s) selected by the user(s) to be converted to a different (or target) style. The source text 402 may be received (or made accessible) by, etc. the system in any suitable manner (e.g., uploading to a server, downloading via online channels, etc.).

The target corpus (or target style corpus or style corpus) 404 may include one or more document (i.e., such as those described above) that includes text that is written, composed, etc. in a particular style. As with the source text, the document(s) of the target corpus 404 may be in any suitable form and include content related to any subject, such as those described above. The document(s) and/or style of the target corpus 404 may be selected by the user(s) (i.e., as the style to which the source text is converted). In accordance with at least some aspects of functionality described herein, the target corpus 404 (and/or the document(s) therein) include text of a particular style (e.g., a target or second style), which may vary depending on the subject(s) or content described therein.

It should be noted that in at least some embodiments the style of the target corpus 404 is different than the (original) style of the source text. Additionally, it should be noted that the source text 402 may include content or subject matter that is not included in the target corpus 404 (i.e., the “meaning” of the content of the source text 402 is different than that of the target corpus 404 and/or the document(s) therein). For example, the source text 402 may be (or include) a document that is intended to be read (or consumed, viewed, etc.) by individuals with little or no experience in a particular field (such as those described above), while the target corpus 404 (and/or the document(s) therein) may be intended to be read by experts in that field.

Still referring to FIG. 4, in the embodiment shown, the source text 402 is analyzed (or evaluated, etc.) by a semantic parsing model 406. As will be appreciated by one skilled in the art, the semantic parsing model 406 may, for example, convert the text (or natural language utterances, content, etc.) of the source text 402 to a logical form or machine-understandable representation of its meaning. In other words, the semantic parsing model 406 may be understood to extract a meaning from each utterance within the source text 406. In particular, in some embodiments, the semantic parsing model 406 generates a meaning (or semantic) representation (or meaning/semantic graph) 408, as is commonly understood, for each sentence (and/or phrase, utterance, etc.) of, or in an “intra-sentence” manner for, the source text.

The output of the semantic parsing model 406 is provided to a discourse planner (or discourse planner model) 410. The discourse planner 410 identifies (or determines, generates, etc.) a meaning representation for the source text 402 at a whole discourse or “inter-sentence” level. In other words, the discourse planner 410 generates a meaning representation for the source text 402 as a whole or a discourse representation (i.e., for the entire document and/or the portion of the document being converted to the style of the target corpus 404). The meaning representation graph(s) (at any level) may include, for example, Abstract Meaning Representations (AMRs) and/or Rhetorical Structure Theory (RST) representations. The discourse planner 410 may also generate and organize nodes (i.e., representative of concepts, entities, etc. within the source text 402) and the relationships between in a linearized set of ordered sub-graphs.

Still referring to FIG. 4, the target corpus 404 is analyzed by a style extract (or extraction) model 412 that is utilized to distill (or extract, determine, etc.) a target style representation 414 (i.e., from the target corpus 404). In some embodiments, this process may include and/or utilize a target language model that is trained on the target corpus 404 combined with determining the difference between an appropriate general language model (e.g., general language model 416) and the target language model. In particular, in some embodiments, the target style representation 414 is determined by and/or based on the difference between the general language model and the target language model.

The output of the discourse planner 410, the target style representation 414, and the general language model 416 (e.g., a pre-trained general language model) are then utilized to perform a text realization process 418. The general language model 416 may be utilized to provide general or overarching information associated with the generation of the particular language (i.e., the spoken/natural language of the source text and/or target corpus, such as English, Spanish, etc.). The target style representation 414 may be utilized to parameterize certain characteristics (e.g., terminology, phrases, target demographics, etc.) of the general language model 416. As such, in some embodiments, from the general language model 416, combined with the target style representation 414 and the output of the discourse planner 410, a target text 420 is generated. The target text 420 may be composed in or with a style that is the same as (or at least similar to) the target corpus 404 but have the same (or at least similar) meaning as the content of the source text 402. Thus, the text realization process may utilize a trained general language model to find the proper phrases and words to express the content expressed in the discourse planner 410 (i.e., representative of the meaning of the source text 402), conditioned on the targeted style representation, in such a way that the generated content within the target text 420 is in an appropriate style for a targeted domain (i.e., as reflected in the style of the target corpus 404). The target text 420 may be provided and/or made available to the user in any suitable manner (e.g., saved on a memory/database, sent via electronic communication, etc.).

As such, in some embodiments, the methods and systems described herein receive a source text and a specified target style (or document(s) in a particular style) as input. The specified target may include a model trained in a desired style or domain or a target corpus for learning the style/domain, as described above. The output of the methods/systems may include a target text document composed in the desired (or target) style/domain. Additionally, in some embodiments, information associated with explainability (i.e., of the generated target text) may be generated. Such may include, for example, highlights of modifications of the source text (or at least portions thereof) when changed to the target text, discourse structure, and probabilistic outputs (e.g., provide an indication of a certain work choice based on a domain-specific language model).

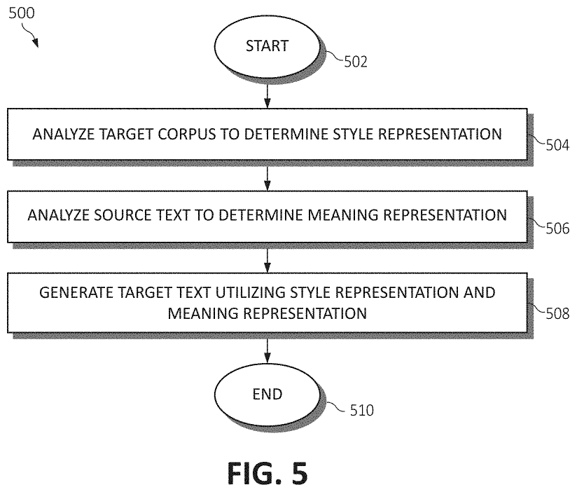

Turning to FIG. 5, a flowchart diagram of an exemplary method 500 for (automated) generation of text with a target (or targeted) style is provided. The method 500 begins (step 502) with, for example, a corpus (e.g., one or more documents) in a (target) style desired by the user being selected (e.g., by the user). Additionally, the user may select a text to have converted or translated into the target style. The corpus and/or text(s) may be uploaded to and/or made accessible by the systems described herein.

The target corpus is analyzed to determine a style representation associated with the target corpus (step 504). The analyzing of the target corpus to determine the style representation may include determining a difference between a target language model associated with the target corpus and a general language model. The analyzing of the target corpus to determine the style representation may further include training the target language model utilizing the target corpus. The target corpus may include a plurality of text documents.

The source text is analyzed to determine a meaning representation associated with the source text (step 506). The analyzing of the source text may be performed utilizing a semantic parsing model. The meaning representation associated with the target corpus may include at least one of an Abstract Meaning Representation (AMR) and a Rhetorical Structure Theory (RST) representation. A style associated with the target corpus may be different than a style associated with the source text. A meaning associated with the source text may be different than a meaning associated with the target corpus.

A target text is generated utilizing the target style representation associated with the target corpus and the meaning representation associated with the source text (step 508). In other words, the generated target text may be composed in the same (or a similar) style as the target corpus but have the meaning of the source text, as described above.

Method 500 ends (step 510) with, for example, the generated target text being provided and/or made available to the user. In some embodiments, feedback from users may be utilized to improve the performance of the system over time.

As such, in some embodiments, methods and/or systems that amend the style and representation of a body of text towards a target text style are provided. A style extract model may be utilized to identify and extract the target style representation from a corpus of target text (e.g., particular scientific journal, business magazine, etc.). A semantic parsing model may be utilized to extract a meaning representation from a source text (i.e., the text that is to be modified). A discourse planner may be utilized to identify a meaning representation at a whole discourse level. A general language model may be utilized to produce the target text based on the outputs of the target style representation and the discourse planner. Also, in some embodiments, the ability to extract information on the produced text and provide information to the user on the text selection, information such as confidence in chosen terminology, highlighted modifications, etc. is provided. Also, in some embodiments, the user may be provided with multiple generated target texts (e.g., perhaps with slightly different styles) from which they may select their preference.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for generating text with a target style, by a processor, comprising:
analyzing a target corpus to determine a style representation associated with the target corpus;
analyzing a source text to determine a meaning representation associated with the source text; and
generating a target text utilizing the target style representation associated with the target corpus and the meaning representation associated with the source text.

2. The method of claim 1, wherein the analyzing of the target corpus to determine the style representation includes determining a difference between a target language model associated with the target corpus and a general language model.

3. The method of claim 2, wherein the analyzing of the target corpus to determine the style representation further includes training the target language model utilizing the target corpus.

4. The method of claim 1, wherein the analyzing of the source text is performed utilizing a semantic parsing model.

5. The method of claim 1, wherein the meaning representation associated with the target corpus includes at least one of an Abstract Meaning Representation (AMR) and a Rhetorical Structure Theory (RST) representation.

6. The method of claim 1, wherein the target corpus includes a plurality of text documents.

7. The method of claim 1, wherein a style associated with the target corpus is different than a style associated with the source text, and wherein a meaning associated with the source text is different than a meaning associated with the target corpus.

8. A system for generating text with a target style comprising:
a processor executing instructions stored in a memory device, wherein the processor:
analyzes a target corpus to determine a style representation associated with the target corpus;
analyzes a source text to determine a meaning representation associated with the source text; and
generates a target text utilizing the target style representation associated with the target corpus and the meaning representation associated with the source text.

9. The system of claim 8, wherein the analyzing of the target corpus to determine the style representation includes determining a difference between a target language model associated with the target corpus and a general language model.

10. The system of claim 9, wherein the analyzing of the target corpus to determine the style representation further includes training the target language model utilizing the target corpus.

11. The system of claim 8, wherein the analyzing of the source text is performed utilizing a semantic parsing model.

12. The system of claim 8, wherein the meaning representation associated with the target corpus includes at least one of an Abstract Meaning Representation (AMR) and a Rhetorical Structure Theory (RST) representation.

13. The system of claim 8, wherein the target corpus includes a plurality of text documents.

14. The system of claim 8, wherein a style associated with the target corpus is different than a style associated with the source text, and wherein a meaning associated with the source text is different than a meaning associated with the target corpus.

15. A computer program product for generating text with a target style, by a processor, the computer program product embodied on a non-transitory computer-readable storage medium having computer-readable program code portions stored therein, the computer-readable program code portions comprising:
an executable portion that analyzes a target corpus to determine a style representation associated with the target corpus;
an executable portion that analyzes a source text to determine a meaning representation associated with the source text; and
an executable portion that generates a target text utilizing the target style representation associated with the target corpus and the meaning representation associated with the source text.

16. The computer program product of claim 15, wherein the analyzing of the target corpus to determine the style representation includes determining a difference between a target language model associated with the target corpus and a general language model.

17. The computer program product of claim 16, wherein the analyzing of the target corpus to determine the style representation further includes training the target language model utilizing the target corpus.

18. The computer program product of claim 15, wherein the analyzing of the source text is performed utilizing a semantic parsing model.

19. The computer program product of claim 15, wherein the meaning representation associated with the target corpus includes at least one of an Abstract Meaning Representation (AMR) and a Rhetorical Structure Theory (RST) representation.

20. The computer program product of claim 15, wherein the target corpus includes a plurality of text documents.

21. The computer program product of claim 15, wherein a style associated with the target corpus is different than a style associated with the source text, and wherein a meaning associated with the source text is different than a meaning associated with the target corpus.
